(19) United States
(12) Patent Application Publication
(10) Pub. No.: US 2006/0285686 A1
(43) Pub. Date: Dec. 21, 2006

(54) Apparatus and method for processing streams

(75) Inventors: Sebastiaan Antonius Fransiscus Arnoldus Van Den Heuvel, Eindhoven (NL); Petrus Johannes Lenoir, Eindhoven (NL); Albert Maria Arnold Rijckaert, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/539,386

(22) PCT Filed: Dec. 1, 2003
(86) PCT No.: PCT/IB03/05726

§ 371 Date: Jun. 15, 2005

(30) Foreign Application Priority Data
Dec. 20, 2002 (EP) 02080590.9

(51) Int. Cl. H04N 7/167

(52) U.S. Cl. 380/200

(57) ABSTRACT

For conditional access purposes a stream is used in which at least two different decryption algorithms are needed for decryption of packets that encode different interspersed parts of the same signal for (quasi-)continuous rendering (such as an audio or video signal). Information is included in the stream to indicate dynamically which decryption algorithm should be used for which packets. In this way, it is possible for example to use a more robust algorithm with a less frequently changing key and a less robust algorithm with a more frequently changing key, interspersed with one another for the same signal. Also, different algorithms may be used for transcrypted and not transcrypted-packets of the same signal for example when an alternative is needed for the original encryption algorithm that was used for the non-transcrypted packets.

The invention relates to methods, systems and apparatuses for processing encrypted streams of data. The invention further relates to a method and apparatus for transcrypting such as stream, and to a stream of data.

In known conditional access systems streams of video data are supplied via wireless (electromagnetically radiating) or cable connections. The video data is included in encrypted packets to ensure that only authorized users are able to enjoy viewing a program from the stream. The stream may contain one or more “programs” in parallel. Programs are similar to channels in the broadcast spectrum: each represents a signal for use continuous or quasi-continuous rendering such as a series of audio samples or a series of television frames.

A user that wants to view a certain program uses a decoder to select the video packets for that program and to decrypt the video information from those packets. Only those users that have been provided with appropriate control words for decryption are able to enjoy viewing the stream.

The control word that is needed to decrypt the stream is changed regularly, for example every few seconds, to make hacking less attractive. Regular control word changes imply that new control words have to be conveyed with the stream on a regular basis. These control words are conveyed in encrypted form, usually with a stronger encryption algorithm than the packets, so that the encrypted control words can less easily be hacked.

A problem with the changing of control words and also with the need to decrypt new control words occurs when the stream is processed other than in a normal replay mode. For example, when the stream has been recorded and is replayed in a trick mode (fast forward, reverse play etc.), the changing control words make it more difficult to provide the correct control words for decrypting the packets. Moreover, the need to decrypt the control words themselves imposes limits on the play rate at which the video information can be decrypted. Similar problems occur for example in special audio modes, such as fast forward, backward and fast back while making brief parts of the audio signal audible.

Another problem that is associated with use of a series of changing control words is that control words control access to a signal in an inflexible way: one must either provide the authorization key to decrypt all the control words or no authorization key at all. It is not possible to provide access to only parts of the signal that are interspersed with inaccessible parts on a fine time-scale. Providing some control words separately, i.e. so that the authorization does not need to be revealed, is of little use when the required control word changes quickly, while on the other hand protection against hacking is compromised if the control word changes too slowly. Of course, the latter is not a problem if the decryption algorithm is sufficiently robust against hacking, but unfortunately a more robust decryption algorithm generally requires more computation power.

Among others, it is an object of the invention to provide for a way of processing a stream of encrypted data that permits more flexible access to a signal for continuous or quasi-continuous rendering.

Among others, it is another object of the invention to provide for a way of processing a stream of encrypted data in which a less frequently changing decryption key can be used for part of the signal than for another part of the signal without decreasing robustness against hacking proportionally to the decrease in frequency of key changes.

Among others, it is another object of the invention to provide for a way of generating a stream of encrypted data that permits simplified access in special modes, while providing robustness against hacking.

Among others, it is a further object of the invention to provide for a way of transcrypting a stream of encrypted data into a form that permits simplified access.

Among others, it is an object of the invention to provide for a stream of information that permits simplified decryption of information.

Among others, it is an object of the invention to provide for a stream of video information that permits simplified decryption during a trick mode.

According to the invention a stream is used in which at least two different decryption algorithms are needed for decryption of packets that encode different interspersed parts of the same signal for (quasi-)continuous rendering (such as an audio or video signal). Information is included in the stream to indicate dynamically which decryption algorithm should be used for which packets. A packet is generally a unit of decryption. By “different” algorithms generally is meant that the algorithms do not merely perform the same computations but with different key values, or that at least if the same series of computations is used, computations with keys of different size are used. Examples of known different algorithms are DES, 3DES, AES, RSA, DVB-CSA.

The stream is processed with an apparatus and method for decryption that is able to use more than one different algorithm for different packets according to algorithm selection information from the stream. Similarly an apparatus and method for encryption use different forms of encryption for different packets so that different decryption algorithms are needed to decrypt the packets. A method and apparatus for transcryption may use encrypted packets from a stream and replace a subset of these packets after decryption and reencryption for a different decryption algorithm.

In this way, it is possible for example to use a more robust algorithm with a less frequently changing key and a less robust algorithm with a more frequently changing key, interspersed with one another for the same signal. Also, different algorithms may be used for transcrypted and not transcrypted-packets of the same signal for example when an alternative is needed for the original encryption algorithm that was used for the non-transcrypted packets. The reason for this may be that the algorithm is not known or may not be applied for some reason.

More particularly in video streams packets with information about individually decodable video frames (I-frame in case of MPEG) on one hand and dependent video frames (P and B frames in case of MPEG) on the other hand may be encrypted with different encryption algorithms to permit access to individually decodable video frames separately from the other frames, preferably with a slowly changing or unchanging key and a more robust decryption algorithm.

Preferably, the stream provides for selection of the decryption algorithm for each packet individually, i.e. on a packet by packet basis, preferably in the packet. In an embodiment selection of the algorithm is combined for one of the algorithms with selection of keys from the stream. For this purpose the stream preferably includes a selection code that may assume different values to select a first decryption algorithm and respective available keys and one other value to select the second decryption algorithm irrespective of the key, for example: a first value selecting the first decryption algorithm and a first key for that algorithm, a second value also selecting the first decryption algorithm but a second key for that algorithm and a third value selecting a second decryption algorithm, a standard available key being used always with the second algorithm.

In another embodiment two types of keys (also called control words) are used interspersed with one another for decrypting packets from the stream, a first key that regularly changes and a second key that does not change or changes less frequently than the regularly changing decryption key change. The second key may be kept the same throughout the stream, or if it changes it should at least change at a lower frequency than the first keys. Part of the packets with video information is encrypted for decryption with the first key and another part is encrypted for decryption with the second key. Thus, during special forms of access, such as for trick mode replay, a part of the packets with video information for the program can be accessed with the second key that requires no or fewer key changes during trick play.

In an embodiment the packets that are encrypted with the unchanged or slower changing key contain independently decodable frames of video information (in case of an MPEG stream, for example, this includes I-frames) and the packets that are encrypted with changing keys contain frames whose decoding is dependent on other frames (P and B frames in case of MPEG). Thus, during trick mode replay these selected frames can be accessed with only the unchanging or slower changing decryption.

Preferably information is included in the stream to indicate for individual packets which form of decryption is needed. Thus, the stream can be decrypted without additional information. It should be noted that, in known streams with changing keys, it is known to supply current and future keys substantially contemporaneously. Such streams contain information to indicate for each packet individually which of the contemporaneously supplied keys is needed for decryption. According to the invention information is added to this to select between encryption algorithms as well.

These and other objects and advantageous aspects of the methods and products according to the invention will be described in more detail using the following figures:

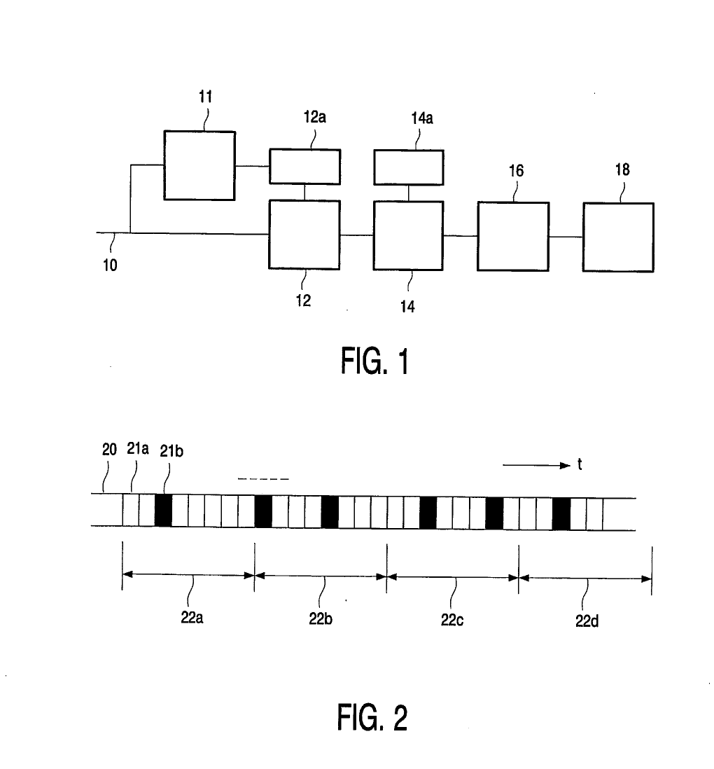

FIG. 1 shows a video decryption and decoding apparatus

FIG. 2 shows a stream of video packets

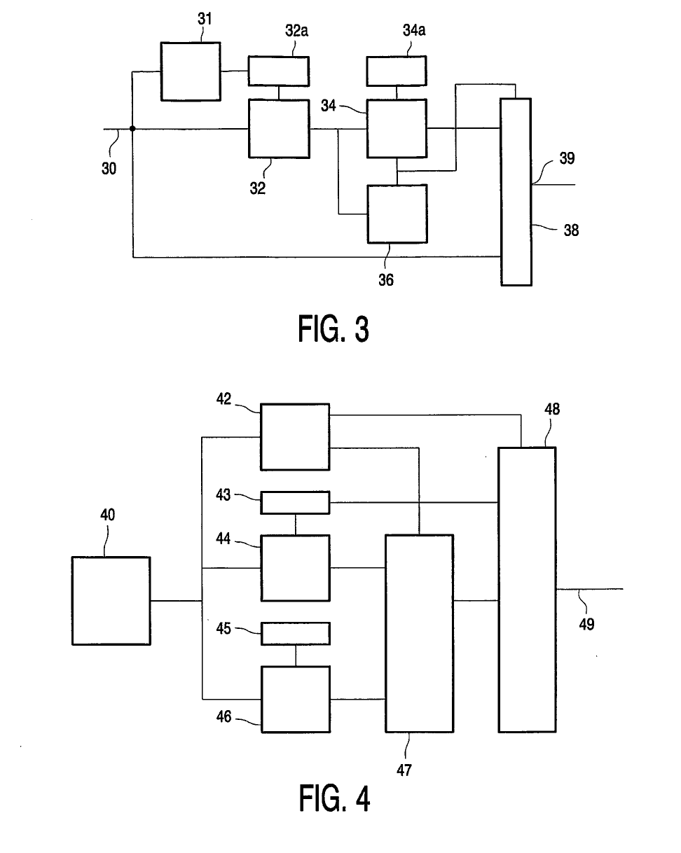

FIG. 3 shows a transcrypting apparatus

FIG. 4 shows an encrypting apparatus.

FIG. 1 shows a video decryption and decoding apparatus. The apparatus contains a cascade of a first decryption unit 12, a second decryption unit 14, a decoding unit 16 and a rendering unit 18. The apparatus furthermore contains a key extraction unit 11 and a first and second key supply unit 12a, 14a coupled to the first and second decryption unit 12, 14 respectively. An input 10 of the apparatus is coupled to first decryption unit 12 and to key extraction unit 11. Key extraction unit 11 has an output coupled to first decryption unit 12a Typically, key supply units 12a, 14a are part of one or more smart cards with circuits for storing and processing keys, or other circuits that are protected against unauthorized access.

FIG. 2 illustrates a stream 20 of packets 21a,b . . . as a function of time. Part of the packets 21a,b contain a program of encrypted video information, for example a program MPEG encoded video information encoding a series of video frames and/or a sampled audio signal. The packets include first packets 21a and second packets 21b that require different decryption algorithms for decryption. Both first and second packets contain data representing the program (the series of video frames or audio samples) and data from both first and second packets is needed to represent the program completely. Stream 20 is organized into segments 22a-d. In each segment 22a-d a different key is needed for a first decryption algorithm to decrypt first packets 21a with video information from the stream. Second packets 21b (shown in FIG. 2 by hatching) with video information require a common key for decryption in each of segments 22a,b for a second decryption algorithm. The first and second packets contain control bits for indicating whether they are first or second packets and, in case of first packets, which key is needed for decryption.

In addition to the first and second packets 21a,b . . . with video information other packets 21a,b . . . may be present, such as packets 21a,b . . . that contain encrypted keys, for use in decrypting the first packets 21a, and stream 20 may contain packets that contain tables with information about the organization of stream 20. As used herein “video information” refers to information that determines the content of images and/or sound of a program.

Optionally stream 20 encodes a plurality of programs representing different signals (“programs”, as used herein, are similar to channels in broadcast signals in that a plurality of channels may be present running in parallel in stream 20 and that a user may select one of the programs for viewing for some indefinite period of time. Programs in this sense do not refer to temporal sections of the content broadcast in a channel, such as for example sections that contain successive topics like sports, news etc.). Each program contains video information from a respective sub-series of packets 21a,b . . . from the stream. At least one such sub-series contains both said first and second encrypted packets with video information, i.e. first packets that require the first decryption algorithm and different decryption keys in different segments 22a-d and second packets that require the second decryption algorithm and the same key in all segments 22a-d.

In operation the apparatus of FIG. 1 receives stream 20. Packets with encrypted keys are received and decrypted by key decryption unit 11. Key decryption unit 11 passes the decrypted keys to first key supply unit 12a. First decryption unit 12 receives packets 21a,b . . . with video information. First decryption unit 12 determines for respective incoming packets 21a,b . . . whether the respective incoming packet is a first packet, that is, whether that packet should be decrypted with the first decryption algorithm with one of the changing keys for segments 22a-d. If so first decryption unit 12 decrypts the packet with the appropriate key supplied from first key supply unit 12a at least if the packet contains video information for a selected program and passes the packet to second decryption unit 14.

If the packet with video information is not a first packet first decryption unit 12 passes the packet to second decryption unit 14 without decryption. In an alternative mode of operation (e.g. a trick play mode) first decryption unit 12 does not decrypt any packets, but merely passes at least second packets to second decryption unit 14.

Second decryption unit 14 determines whether the packet is a second packet, that is, whether that packet should be decrypted with the second decryption algorithm and the common key that does not change from segment to segment 22a-d. If so, second decryption unit 14 decrypts the packet with the appropriate key supplied from second key supply unit 14a at least if the packet contains video information for a selected program and passes the decrypted packet to decoding unit 16. If the packet has already been decrypted by first decryption unit 12, second decryption unit passes the packet to decoding unit 16 without further decryption.

Decoding unit 16 forms a video signal for the selected program from the content of the decrypted packets. In case of an MPEG encoded stream, for example, decoding unit 16 converts MPEG data into a video signal. (It should be noted that “decoding” as used here is distinguished form “decrypting” because it is not aimed at providing conditional access but typically involves decompression. Thus no key is needed for decoding.). Decoding unit 16 passes the decoded video signal to rendering unit 18 which displays an image determined by the video information and/or renders the accompanying sound.

Preferably, the second decryption algorithm used by second decryption unit 14 is more robust against hacking than the first decryption algorithm that is used in first decryption unit 12, so that it is less easy to hack the second decryption without a key than it is to hack the first decryption algorithm. For example, an AES or RSA decryption algorithm may be used in second decryption unit 14 and a less computationally intensive type of algorithm (for example an algorithm such as conventionally used in MPEG transport streams) in first decryption unit 12. As an alternative algorithms that differ only by using a longer key in second decryption unit 14 than in first decryption unit 12, for example using a 128 bit key for one algorithm and a 256 bit key for another algorithm. Using a larger key is a simple way of increasing robustness against hacking. As another alternative the algorithms may differ in their decryption block size.

In principle, second key supply unit 14a may supply an unchanging key from a memory (not shown separately). However, without deviating from the invention, the key supplied from second key supply unit 14a may change, albeit at a much lower rate than the key from first key supply unit 12a, i.e. remaining the same over two or more segments 22a-d. In this case second key supply unit 14a may have an input coupled to a key source, for example to key extraction unit 11 for receiving updates of the key, although other sources, e.g. an external telephone line (not shown), a smart card containing one or more key values, or the Internet, may be used to supply the key.

The apparatus of FIG. 1 permits a first and a second type of access. In the first type of access all packets of video information for a program are decrypted either by first decryption unit 12 or by second decryption unit 14 and decoded by decoding unit 16 for rendering by rendering unit 18. In the second type of access only the second decryption unit 14 is used to decrypt packets with video information. This second type of access is used for trick mode replay purposes for example, in which only selected frames are rendered during fast forward or fast reverse for example. In another example the second type of access may be used to generate video signals for subscribers who have limited rights of access to stream 20, for example to tease the subscribers into taking a full subscription.

During trick mode replay a replay device (not shown), such as a magnetic or optical disc drive is coupled to input 10. Selected frames are rendered by rendering unit 18. From the replay device information from the stream is fed to input 10 in the direction and at the speed corresponding to a selected trick mode (e.g. fast forward or fast reverse) so that packets containing video information for the required frames are supplied in time and in order for rendering. (The replay device may select the packets on the basis of information that indicates whether the second decryption unit should decode the packets). Techniques for rendering selected frames in trick mode replay are known per se, provided the packets with video information for the relevant frames are available in unencrypted form. The apparatus of FIG. 1 ensures that these packets are decrypted when supplied by the replay device.

It will be appreciated that various modifications may be applied to the apparatus of FIG. 1 without deviating from the invention. For example, the apparatus is not necessarily limited to MPEG streams or indeed to video or audio data. Furthermore, although the different decryption algorithms preferably differ in the computation steps that have to be performed (this provides the most effective way of changing robustness), one may also use different algorithms that use the same computational steps but with keys of different size, so that the computations involve wider operands for the more robust algorithm. A wider key generally provides more robustness. In an embodiment of a video decoding system one may even use the same algorithm, the first and second packets merely differing in the frequency with which their required keys are updated.

Furthermore, although different decryption units have been shown, alternatively a single decryption unit may be used instead, which switches back and forth between two algorithms. The decryption unit or units may be implemented as dedicated hardware, or as a programmable processor programmed to apply the relevant decryption algorithms. Similarly the various other units of the apparatus of FIG. 1 may be implemented as dedicated hardware units known per se or as suitably programmed computers, in which case one or more of the units may be implemented using different programs on one computer.

It will also be appreciated that without deviating from the invention, when different decryption algorithms are used for interspersed packets, their keys may in fact change just as frequently. This increases robustness and/or flexibility, be it with the disadvantage of requiring more key communication. Also, the first and second decryption algorithm may be just as robust. In this case no gain in robustness is made, but this makes the apparatus suitable for decrypting streams that use different algorithms for other reasons. Furthermore, although use of only two different decryption algorithms has been described, because this requires a minimum amount of overhead, it will be appreciated that of course more than two different decryption algorithms may be used for the same program, with information in the stream indicating which decryption algorithm should be used. This increases flexibility.

FIG. 3 shows a transcrypting apparatus for converting a stream with packets of video information that are encrypted using regularly changing keys into a stream of the type shown in FIG. 2. Although the transcrypting apparatus is shown separately from FIG. 1, it will be understood that it may be comprised in the same apparatus as at least part of the decryption apparatus of FIG. 1, some units of that apparatus performing functions in the transcrypting apparatus as well. These units may be contained in a set-top box, i.e. a device preceding rendering unit 18. Thus, for example in a system with a recording device, the transcrypting part of the apparatus may serve to prepare an incoming stream for storage in the storage device, or to modify a stored stream in the storage device, while during replay the decrypting part of the apparatus performs decryption of a stream replayed from the storage device.

The transcrypting apparatus of FIG. 3 contains a key decryption unit 31, a decryption unit 32 and a first key supply unit 32a connected to an input 30 as described for key decryption unit 11, first decryption unit 12 and a first key supply unit 12a of FIG. 1. The transcrypting apparatus furthermore contains an encryption unit 34, a second key supply unit 34a, a packet selection unit 36 and a multiplexer 38. The output of decryption unit 32 is coupled to inputs of encryption unit 34 and packet selection unit 36. Encryption unit 34 has a key input coupled to second key supply unit 34a Packet selection unit 36 has an output coupled to a control input of multiplexer 38. Multiplexer 38 has inputs coupled to input 30 and an output of encryption unit 34.

In operation the transcrypting apparatus receives a stream with packets of encrypted video information. In successive segments of the stream different keys are needed to decrypt the video information. The transcrypting apparatus forms an output stream at output 39. The output stream corresponds to the input stream in which selected packets of encrypted video information from the incoming stream have been replaced by substitute encrypted packets that are obtained by decrypting the selected packets and reencrypting the packets with an encryption algorithm that requires a different decryption algorithm for decryption compared with the original incoming packets and preferably an encryption key that does not change or changes less frequently than the keys needed to decrypt the packets of video information in different segments. Decryption unit 32 performs the decryption and encryption unit 34 performs the encryption.

Packet selection unit 36 selects the packets that are replaced and signals to multiplexer 38 whether to output a packet from the input stream or its replacement (multiplexer 38 generally will require a delay element (not shown) to compensate for delays due to decryption, encryption and detection).

In a typical MPEG embodiment packet selection unit 36 selects the packets on the basis of whether they contain video information for I frames or not. Only packets with information for I-frames are replaced. More generally, if the invention is applied to preparing the stream for trick mode replay, packet selection unit 36 preferably selects packets that contain video information for frames that can be decoded independent of other frames. However, for other applications a different selection may be made e.g. selecting a subset of I frames to enable access to stills from the stream or any other form of reduced access.

The nature of encryption of the packets may be indicated using information bits in the packets. Preferably, these information bits select between the control words to be used and, when mutually different algorithms are used for decrypting packets with changing and unchanging control words (or more slowly changing control words), between decryption algorithms. First decryption unit 12 and second decryption unit 14 of FIG. 1 each use these information bits to determine whether to decrypt the packet according to the algorithm implemented in the relevant decryption unit 12, 14 or to pass the packet without decryption.

In MPEG streams it is known to include pairs of encrypted control words in the stream, generally a current control word (needed to decrypt video information from packets in the same segment of the stream in which the control word is included) and a future control word (needed to decrypt packets from the next segment). These streams use a two-bit code in all decryptable packets, one bit to indicate which of the future and current control word should be used to decrypt the packet, and another bit to control whether the packet should be decrypted at all, or passed without decryption.

According to an embodiment of the present invention these two-bit codes are also used to select between different algorithms, for example by using the two-bit codes to selectively activate different decryption units 12, 14. Thus, a first value represented by the two-bit code may select a first decryption algorithm, using a first regularly changing control word, a second value may select the first decryption algorithm, using a second regularly changing control word and a third value selects a second decryption algorithm using a third control word that does not change when the first and second control words change (or changes less frequently).

In principle the not or slowly changing control word may be supplied independent of the stream, for example by storing unchanging control words in second key supply units 14a, 34a. In a further embodiment this control word may be supplied as part of the stream. In this embodiment the transcrypting apparatus of FIG. 3 is preferably adapted to supply frames with this control word to output 39 as part of the output stream.

FIG. 4 shows an embodiment of an encryption apparatus that implements the invention. Although encryption according to the invention has been described in terms of transcryption and the encryption apparatus may be used in transcryption after decrypting an incoming stream, it will be understood that the encrypting apparatus may be applied to a stream from the outset, that is, when the stream is first encoded and/or encrypted. The encryption apparatus contains a source 40 of signal data, such as for example MPEG encoded video data. The apparatus contains an algorithm selection unit 42, a first key supply unit 43, a first encryption unit 44, a second key supply unit 45, a second encryption unit 46, a packet multiplexer 47 and a stream output unit 48. Source 40 is coupled to selection unit 42 and first and second encryption unit 44, 46. First and second key supply unit 43, 45 are coupled to first and second encryption unit 44, 46 respectively. Outputs of first and second encryption unit 44, 46 are coupled to data inputs of packet multiplexer 47. A control input of packet multiplexer is coupled to selection unit 42. Outputs of packet multiplexer 47, selection unit 42 and first key supply unit 43 are coupled to stream output unit 48, which has an output coupled to an output 49 of the apparatus.

In operation, source 40 produces a series of unencrypted packets for one or more signals such as programs suitable for use in an MPEG transport stream. Encryption units 44, 46 encrypt the packets using different encryption algorithms (or at least so that different decryption algorithms are needed for decrypting the packets) with keys supplied by key supply units 43, 45. Generally, the key supplied by first key supply unit 43 changes more frequently than that supplied by second key supply unit 45, which does not change at all in an embodiment. First key supply unit supplies the changing keys, generally in encrypted packets, to stream forming unit 48. Preferably, more than one key is included in each packet, for example a currently used key and a next new key that will be used encrypting future packets of the signal. In this case, each time when a key changes, the changed key replaces the oldest key in the packet so that even and odd keys may be distinguished dependent on the place in the packet.

Selection unit 42 selects which decryption algorithm should be applied to respective packets and controls packet multiplexer 47 to pass the packet from the encryption unit 44, 46 that applies the encryption algorithm corresponding to the selected decryption algorithm. Generally selection unit selects the first and second algorithm interspersed with one another, for example choosing the second algorithm for packets that contain information about I frames and the first algorithm for other packets. However, other forms of selection may be used as well, for example periodically selecting a short segment of a signal for encryption with the second algorithm. Selection unit 42 passes information that indicates which decryption algorithm should be used for the packet to stream forming unit 48.

Stream forming unit 48 includes the encrypted packets, the keys from first key supply unit 43 and the algorithm selection information from selection unit 48 in an output stream. Preferably, stream forming unit 48 includes the indication which decryption algorithm should be used for a packet in the packet itself. For example, a code may be used that selects both the key for the first decryption algorithm from the keys transmitted by first key supply unit (the even and odd key) and whether the first or the second algorithm should be used. For example, using a two bit code, with four possible values, a first value might indicate no decryption needed, a second value might indicate first algorithm odd key, a third value might indicate first algorithm even key and a fourth value might indicate second algorithm.

Although provisions have been shown for transmitting keys for the first decryption algorithm in the stream, it will be understood that keys for the second decryption algorithm may be transmitted as well, for use in decryption in a decryption apparatus. In an embodiment, even the instructions for executing the second algorithm may even be supplied in the stream. However, if the key is not supplied via the stream, it may be supplied in a different way to a decryption apparatus, e.g. by distributing a smart card containing the key, or via a telephone line, the Internet etc.

Although different encryption units have been shown, alternatively a single encryption unit may be used instead, which switches back and forth between two algorithms. The encryption unit or units may be implemented as dedicated hardware, or as a programmable processor programmed to apply the relevant decryption algorithms. Similarly the various other units of the apparatus of FIGS. 2 and 3 may be implemented as dedicated hardware units known per se or as suitably programmed computers, in which case one or more of the units may be implemented using different programs on one computer.

In principle all programs in a stream may be encrypted or transcrypted in this way, so that each program can be accessed in two ways, using only one of the decryption algorithms or both changing decryption algorithms. However, the invention may also be applied selectively to one or more of the programs in a stream, using conventional forms of encryption for the other programs in the same stream.

In principle all programs in a stream may also be encrypted or transcrypted, a first part of the packets being encrypted or transcrypted with changing control words and a second part (interspersed with the first part)with the same algorithm but with control words that change less frequently than the changing control words. As a result that each program can be accessed in two ways, using either the same decryption algorithm only with an unchanging control words or with both changing and unchanging control words.

Although, as described the two decryption algorithms are used as alternatives, it will be understood that they may also be used cumulatively, so that selected packets are encrypted or decrypted twice (both with changing and unchanging control words), whereas other ones of the packets are not encrypted or decrypted more than once (with changing control words). In this case either both decryption units 12, 14 are active, or only first decryption unit 12. Thus, increased access protection can be realized, for example by using double encryption for certain frames such as I frames, or more flexible exploitation of the stream may be supported, for example by using double encryption for P and/or B frames so that only users equipped with all control words can fully enjoy the stream.

The various units shown in the figures may be implemented each using separate circuit dedicated to the function performed by the unit. Preferably, the key supply units and the decryption units are protected against unauthorized access. In particular, second decryption unit 14 preferably has a stronger protection than first decryption unit, since it uses a more valuable control word. Such a stronger protection need not cause excessive overhead because only part of the packets needs to be decrypted in this decryption unit. The various units may also be implemented as suitably programmed computers. In this case, different units may be implemented using computer programs running on the same processor.

1. An apparatus for processing a stream that contains encrypted packets of information representing a signal for at least quasi-continuous rendering, the apparatus comprising:
a decryption unit for applying selectable ones of a plurality of different decryption algorithms to packets representing the signal; and
an algorithm selection unit for reading algorithm selection information from the stream and for controlling dynamically which of the plurality of decryption algorithms the decryption unit applies to respective ones of the packets from the stream, dependent on the algorithm selection information.

2. The apparatus as claimed in claim 1, wherein at least a first and second one of the algorithms differ in robustness against unauthorized decryption.

3. The apparatus as claimed in claim 2, wherein the first and second one of the algorithms differ in the size of keys used in the respective algorithms.

4. The apparatus as claimed in claim 1, wherein the algorithm selection information selects the algorithm for respective ones of the packets individually, the algorithm selection unit controlling the decryption unit on a packet by packet basis.

5. The apparatus as claimed in to claim 4, wherein algorithm selection unit reads the algorithm selection information for each particular packet from that packet.

6. The apparatus as claimed in claim 1, wherein at least a first one of the decryption algorithms requires a selectable key, the apparatus comprising a key extraction unit for extracting key values for that key from the stream and for supplying the extracted key values to the decryption unit for use as the selectable key when the first one of the decryption algorithms is used.

7. The apparatus as claimed in claim 6, wherein the stream comprises a decryption control code, different values of the control code selecting using a first available key values with the first one of the decryption algorithms, using a second available key values with the first one of the decryption algorithms and using a second one of the decryption algorithms respectively, the algorithm selection unit being arranged to decode the algorithm extraction information from the decryption control code.

8. The apparatus as claimed in claim 6, wherein the apparatus is arranged to obtain a key for use in the second decryption algorithm from outside the stream.

9. The apparatus as claimed in claim 1, wherein the decryption circuit comprises a pipe-line of a decryption units, for decrypting applying different ones of the decryption algorithms respectively, a front one of the decryption units in the pipe-line being arranged to pass packets undecrypted to a succeeding one of the decryption units, when the algorithm selection information indicates that the decryption algorithm applied by the front one of the decryption units need not be applied.

10. The apparatus as claimed in claim 1, switchable between a first and second mode of operation, the apparatus decrypting all packets of the signal in the first mode, the apparatus decrypting only packets that are decryptable with a first one of the decryption algorithms in the second mode.

11. A method of processing a stream that contains encrypted packets of information representing a signal for use in at least quasi continuous rendering, the method comprising the steps of:
reading packets that represent the signal from the stream;
reading algorithm selection information from the stream; and
applying a selected one of a plurality of decryption algorithms to packets representing the signal, the decryption algorithm being selected for respective ones of the packets dynamically on the basis of the algorithm selection information.

12-18. (canceled)

19. An apparatus for outputting a stream containing encrypted packets of information representing a signal for at least quasi-continuous rendering, the apparatus comprising:
an algorithm selection unit for selecting at least one of a plurality of decryption algorithms by which respective ones of the packets should be decryptable, so that the required one of the decryption algorithms changes dynamically in the course of the stream;
an encryption unit for encrypting the packets, the encryption unit being arranged to use a plurality of different forms of encryption for the packets that represent the signal, each form requiring a respective one of the decryption algorithms, the algorithm selection unit controlling which of the forms are used by the encryption unit for generating the respective ones of the packets in the stream; and
an algorithm selection information encoding unit for dynamically encoding selection information in the stream to indicate which of the decryption algorithms should be used for the packets that represent the signal.

20-21. (canceled)

22. The apparatus as claimed in claim 19, the signal being a video signal comprising independently decodable video frames and dependently decodable video frames that are decodable as updates to other video frames, wherein the algorithm selection unit is arranged to select a first one of the decryption algorithms for packets that contain no information from the independently decodable frames and a second one of the decryption algorithms for packets that contain information about the independently decodable frames.

23. The apparatus as claimed in claim 19, the algorithm selecting unit selecting first keys required for the first one of the decryption algorithms, the first keys varying during progress of the stream while a second key for the second one of the decryption algorithms, if any, remains the same, or changes less frequently than the first keys, the second one of the algorithms being an algorithm that is more robust against unauthorized hacking than the first one of the algorithms.

24. The apparatus as claimed in claim 19, wherein the algorithm selection unit is arranged to select the decryption algorithm on a packet by packet basis, the algorithm selection information encoding unit encoding the algorithm selection information for respective ones of the packets individually in the stream.

25. The apparatus as claimed in claim 24, wherein the algorithm selection information encoding unit is arranged to encode the algorithm selection information for each particular packet in that particular packet.

26. The apparatus as claimed in claim 19, wherein the encryption unit encrypts the packets for decryption with the first decryption algorithm so that successively different decryption keys are required for decryption, the packets for decryption with the second decryption requiring a non-changing key, if any, or a key that changes less frequently than the successively different decryption keys of the first decryption algorithm.

27. The apparatus as claimed in claim 26, wherein the second decryption algorithm is an algorithm that is more robust against unauthorized hacking than the first decryption algorithm.

28. The apparatus as claimed in claim 26, the algorithm selection information encoding unit including the algorithm encoding information and key selection information for selecting from available ones of the successively different decryption keys encoded together in a code, so that different values of the code select the first decryption algorithm with different available ones of the successively different decryption keys and the second decryption algorithm respectively.

29. A method of outputting a stream containing encrypted packets of information representing a signal for use in at least quasi continuous rendering, the apparatus comprising the steps of:
selecting a plurality of different decryption algorithms by which respective ones of the packets should be decodable, so that the required one of the decryption algorithms changes dynamically in the course of the stream;
encrypting the packets in the stream so that the selected ones of the decryption algorithms are needed for decrypting the packets; and
dynamically encoding selection information in the stream to indicate which of the decryption algorithms should be used for the packets that represent the signal.

30-38. (canceled)

39. A transcrypting apparatus for transcrypting a stream that contains encrypted packets of information representing a signal for at least quasi-continuous rendering, said transcrypting apparatus comprising:
a stream input and a stream output, for inputting and outputting the stream, respectively;
a selection unit for selecting a subset of packets from a set of packets that represent the signal;
a decryption unit for decrypting the packets of the subset with a first decryption algorithm;
an encryption unit for encrypting the packets of the subset with a form of encryption that requires at least a second decryption algorithm different from the first decryption algorithm;
an algorithm selection information encoding unit for dynamically encoding selection information that indicates which of the first algorithm and at least the second decryption algorithms should be used for which of the packets that represent the signal; and
an output unit for outputting encrypted packets from the stream input that are not contained in the first subset in combination with the packets from the subset that have been encrypted with said form of encryption.

40. (canceled)

41. The transcrypting apparatus as claimed in claim 39, wherein the output unit is arranged to output packets that are not contained in the first subset as encrypted at the stream input, the output unit outputting the packets from the subset that have been encrypted with said form of encryption interspersed with the output packets that are not contained in the first subset.

42. The transcrypting apparatus as claimed in claim 39, the signal being a video signal comprising independently decodable video frames and dependently decodable video frames that are decodable as updates to other video frames, wherein the subset comprises all packets that contain information about the independently decodable video frames.

43. The transcrypting apparatus as claimed in claim 39, wherein the algorithm selection information encoding unit is arranged to encode the selection for respective ones of the packets individually.

44. (canceled)

45. A method of transcrypting a stream containing encrypted packets of information representing a signal for at least quasi continuous rendering, the method comprising the steps of:
receiving the stream;
selecting a subset of packets from a set of packets that represent the signal;
decrypting the packets of the subset with a first decryption algorithm;
reencrypting the packets of the subset with a form of encryption that requires at least a second decryption algorithm different from the first decryption algorithm;
encoding selection information that indicates dynamically which of the first algorithm and at least the second decryption algorithms should be used for which of the packets that represent the signal; and
replacing the packets of the subset in the stream by the reencrypted packets.

46. (canceled)

47. The method as claimed in claim 45, the signal being a video signal comprising independently decodable video frames and dependently decodable video frames that are decodable as updates to other video frames, wherein the subset comprises all packets that contain information about the independently decodable video frames.

48. The method as claimed in claim 45, wherein the algorithm selection information encoding unit is arranged to encode the selection for respective ones of the packets individually.

49. (canceled)

50. An apparatus for processing a stream containing encrypted packets of video information from a program, the apparatus comprising:
a supply circuit for supplying first and second control words for decrypting first and second packets of video information from the program, the supply circuit periodically replacing the first control word using information from the stream while keeping the second control word unchanged during successive changes of the first control word, the supply circuit obtaining control word selection code to select which of the first and second control word will be supplied for respective ones of the packets; and
a decryption circuit arranged to decrypt packets of video information from the program with the keywords supplied by the supply circuit.

51. The apparatus as claimed in claim 50, wherein the decryption circuit is arranged to apply a first and second, mutually different decryption algorithm for decryption of the packets decrypted with the first and second control word respectively, the second decryption algorithm being more robust against unauthorized hacking than the first decryption algorithm.

52. The apparatus as claimed in claim 50, wherein said apparatus is switchable between a first mode and a second mode, so that in the first mode, both first and second packets of the program are decrypted, and in the second mode, only second packets of the program are decrypted.

53. The apparatus as claimed in claim 52, wherein the apparatus further comprises a decoding unit arranged to produce a trick play video signal of the program from the decrypted second packets in the second mode and a normal play video signal of the program from the decrypted first and second packets in the first mode.

54. The apparatus as claimed in claim 50, wherein the decryption circuit is arranged to distinguish between the first and second packets on the basis of information included in the packets.

55. An apparatus for transcrypting an input stream of encrypted packets of video information from a program, the apparatus comprising:
a decryption unit coupled to a stream input for receiving packets of video information from the program, the decryption unit being arranged to decrypt the packets using regularly updated first control words;
an encryption unit coupled to the decryption unit for receiving decrypted packets and re-encrypting the packets using a second control word that does not change or changes less frequently than the first control words;
a packet selection unit, coupled to the stream input for detecting selected packets; and
a stream forming unit coupled to the stream input, to an output of the encryption unit and the packet selection unit for forming an output stream from the input stream, wherein the selected packets are replaced by the re-encrypted packets.

56. The apparatus as claimed in claim 55, wherein the encryption unit is arranged to re-encrypt the packets of video information from the program with an encryption process that is more robust against unauthorized hacking than the first decryption algorithm.

57. The apparatus as claimed in claim 56, wherein the packet selection unit is arranged to select the selected packets according to whether the selected packets contain information of video frames that are decodable independently, without reference to other video frames.

58. The apparatus as claimed in claim 56, wherein the encryption unit is arranged to include in the output stream selection information to indicate for each packet individually whether a first or second decryption process should be used.

59. A stream of data that contains encrypted packets of information representing a signal for at least quasi-continuous rendering, the stream of data comprising:
algorithm selection information indicating for interspersed packets of the signal which of a plurality of different decryption algorithms should be used for decrypting respective ones of the packets of the signal; and
packets of the signal encrypted so that different decryption algorithms have to be used for decrypting different ones of the packets.

60-62. (canceled)

63. A system for processing a stream that contains encrypted packets of information representing a signal for at least quasi continuous rendering, the system comprising:
an algorithm selection unit, for selecting at least one of a plurality of decryption algorithms by which respective ones of the packets should be decodable, so that the required one of the decryption algorithms changes dynamically in the course of the stream;
an encryption unit for encrypting the packets, the encryption unit being arranged to use a plurality of different forms of encryption for the packets that represent the signal, each form requiring respective ones of the decryption algorithms, the algorithm selection unit controlling which of the forms are used for the respective ones of the packets by the encryption unit;
an algorithm selection information encoding unit for dynamically encoding selection information in the stream to indicate which of the decryption algorithms should be used for the packets that represent the signal.
a decryption unit arranged for applying selectable ones of a plurality of different decryption algorithm to packets representing the signal; and
an algorithm selection unit arranged to read the algorithm selection information from the stream and to control dynamically which of the plurality of decryption algorithms the decryption unit applies to respective ones of the packets from the stream, dependent on the algorithm selection information.
